(19) United States
(12) Patent Application Publication
(10) Pub. No.: US 2009/0274893 A1
(43) Pub. Date: Nov. 5, 2009

(54) METHOD FOR MANUFACTURING CARBON BLOCKS

(75) Inventors: Govind Bommi, Bayshore Park (SG); Krishna Murthy Bommi, Bangalore (IN)

Correspondence Address: Levenfeld Pearlstein, LLC;Intellectual Property Department, 2 North LaSalle, Suite 1300, Chicago, IL, 60602, US

(73) Assignee: FILTREX HOLDINGS PTE LTD., Parklane Mall (SG)

(21) Appl. No.: 12/112,603

(22) Filed: Apr. 30, 2008

(51) Int. Cl. B32B 3/26; B29C 47/38

(52) U.S. Cl. 428/319.1; 264/209.2; 264/150

(57) ABSTRACT

A method for continuous extrusion of activated carbon tubular shapes used in a water filtration device and process for making same. A mixture of primarily activated carbon and polymeric binder is gravity fed into an extruder barrel through a slide to facilitate uniform feed. The binder is surface charged by a plasma process to attach to the carbon with a weak force. The barrel is heated by induction heating to provide high and constant heat source. A desired porosity in the carbon profile is achieved by varying the mesh size of the carbon and binder along with changing the pitch in the screw.

### BACKGROUND OF THE INVENTION

Clean water is a universal necessity. Carbon, in particular granulated activated carbon, has long been used to filter water to remove taste and odors. Water flows around the carbon granules and mechanical separation filters out particles while activated carbon or other additives adsorb chemical contamination. However, as the water flows in granulated activated carbon (GAC), the water takes the path of least resistance, forming channel flow. Channel flow reduces the amount of effective surface area in the GAC. Other concerns include the potential for growth of bacteria in the filter and slow adsorption rate. Therefore, GAC filters are not effective in removing chemical substances of health concern.

Carbon block filters, on the other hand, are an effective way to filter unhealthy substances from the water. Carbon blocks are commonly used in water filtration applications to remove suspended impurities, dissolved organics, taste, and odor. Carbon blocks are also used to remove harmful contaminants such as heavy metals and microorganisms.

Carbon blocks are rated based on the size of particulate matter, measured in microns, the block can filter from the water. A block capable of filtering a 1 micron particle is considered a tight carbon block while a carbon block capable of filtering a 15 micron particle is considered a more porous block. The tighter the carbon block, or the smaller the micron rating, the more resistance there is in filtering and the greater the pressure drop across the carbon block. The carbon powder mesh size and the type of polymer binder used vary depending on the porosity required in the carbon block. The higher the mesh, the tighter or less porous the carbon block. In addition to the carbon powder, in some applications special additives are blended to remove specific contaminants such as lead, bacteria, and the like.

Carbon blocks are generally formed using activated carbon powder along with polymeric binder. The carbon block is made in a predominately tubular, porous form in which the water to be purified is passed from the outside to the inside of the block. Inside is an annular, hollow opening where water can flow out of the carbon block. This type of carbon block filter is commonly known as a depth filter having a tortuous path of pores, rather than an absolute pore barrier as in surface filtration.

Porous carbon block is generally manufactured via a sintering process. Sintering is an age old process for making objects with porosity from powdered mixtures by heating the mixture to below the binder's melting point until the particles adhere to each other. For example, in the metal industry, sintered bronze is used for bearing applications because its porosity allows lubricant to flow through it or remain captured within. Depending on the porosity needed, the sintering process can be pressure-less forming, cold pressing, or hot pressing.

Porous carbon blocks are sintered in either a compression or an extrusion process. In the compression process, a mixture of activated carbon and polymeric binder is poured into a mold and sintered at temperatures below the melting point of the binder. Technically, any shape can be manufactured in a compression process. The pressure drop and water flow characteristics through the block are a function of the type of binders used.

Extrusion is another process by which carbon blocks are commonly manufactured. In the extrusion process, the mixture of carbon and binder is extruded to form a continuous porous block usually tubular in shape. Currently, separate feed and die sections are used to form the porous block.

A porous carbon tubular shape can be formed in a single screw extruder using the principals of plastic extrusion, in which the mixture simply melts and a single screw forces the melted mixture through a die to form the shape of the die. The final shape can be a solid rod, hollow pipe, or any number of profiles. In plastic extrusion, the mixture is melted by external heat and conveyed forward by a screw in a barrel and forced out through a die to form the final shape. Final cooling outside the die solidifies the plastic and the plastic retains the profile in the die. The shaped mixture is cooled and cut to length.

For carbon blocks, the binder is softened by an external heat allowing the binder to sinter to the carbon powder in the barrel. The mixture is forced out a die to form the hollow tubular shape which is cooled and cut to length to make water filter cartridges. In order to have uniform flow through the feed screw, generally a vertical auger type screw in the hopper is placed directly over the barrel.

The mixture is fed to the die assembly through a feed screw. The pressure and temperature in the die assembly are adjusted to a desired porosity in the blocks. In this process, low temperature binders are commonly used for it is difficult to increase the temperature to use binders with higher melting points. In the carbon block, low melting binders such as LDPE, however, have a tendency to have melt, flow, and cover the carbon surfaces. The available surface area of the carbon particles is covered by the binder when the binder is allowed to melt and flow, making the carbon less efficient in adsorbing capacity and water filtering.

The carbon blocks are also subjected to back pressure to obtain desirable porosities. Back pressure is used in continuous extrusion of composite solid articles having a porous structure. Similar mixtures of carbon and binder are subjected to various back pressures to achieve different porosities of blocks. The back pressure is generated in the die assembly from equipment outside the die assembly. This back pressure allows different porosities of carbon block to form, depending on the back pressure applied. Less back pressure causes a more porous block to form; more back pressure causes a less porous, tighter block to form.

This aforementioned process is a complex process to achieve porous tubular carbon composites and there are several practical limitations in the current process of continuous extrusion of porous carbon blocks.

First, the process is complex and needs a high skill level to operate the current process to achieve the desired output. The flow and feed of the mixture of carbon and binder through the feed screw is critical to ensure the proper quantity of each is flowing through the die assembly for consistency of the carbon porosity. Due to the variation of carbon powder and binder particle size and density there is a tendency for the carbon powder and binder to separate in the hopper of the extruder. This causes inconsistencies in the feed into the barrel of the extruder. The binder and carbon need to be mixed in an elaborate manner in order to force point-bonding to prevent separation of the binder and carbon powder.

In addition, low molecular weight binders are currently used in carbon blocks because of the ease in melting. However, it is difficult to heat the low molecular weight binder to its melting temperature without melting the binder too much to cause flow over the carbon particles and thus, cover the effective surface area of the carbon particles. If a high molecular weight binder is used to overcome this difficulty, a higher temperature must be attained. To produce a higher temperature to melt a higher molecular weight binder, the barrel of the extruder must be very long to have the mixture be in contact with the heating source for a sufficient time while being moved or the mixture must remain stationary in the heated portion of the extruder for a relatively long time.

Moreover, in current practice, the porosity in the carbon composite is achieved by increasing the back pressure in the die. This causes enormous pressure in the system and also is not a reliable way to achieve consistent porosity in the carbon composite.

Furthermore, there is a challenge to creating a homogenous carbon block when blending two and more materials with various bulk densities and also of various particle size distributions. In addition to the variation of bulk density and particle size distribution, both activated carbon and polymeric binder have no surface charge and therefore, separate in the hopper and while feeding into the barrel. When there is separation of the mixture in the blend, the mixture fed into the hopper is not of constant consistency and hence, the carbon block is not consistent in its density and performance. Furthering separation of the blend, when the hopper is placed directly on the hopper and mixture is fed by gravity into the barrel, there are bridging issues at the throat of the hopper which adds to the inconsistency of feed of the mixture 16 into the barrel.

Therefore, a method for extruding carbon blocks to overcome all the shortcomings of the current extrusion process is needed. Desirably, the method is easy to understand and requires only minimal knowledge to use. Also, it is desirable that such a method allow for the proper quantity and size and mixture to be mixed to flow. Additionally, such a method provides a way to decrease the separation of the materials in the mixture and provide for a consistent, uniform block. Finally, it would be desirable for the method to deliver reliable, consistent porosity within the carbon block.

### BRIEF SUMMARY OF THE INVENTION

A method and apparatus for continuous extrusion of activated carbon tubular shapes used in filtration of water is herein disclosed and claimed. A mixture of primarily activated carbon and polymeric binder is gravity fed into an extruder barrel through a slide to facilitate uniform feed, preventing bridging. To prevent the separation of the carbon and binder, the binder is surface charged by a plasma process to attach to the carbon with a weak force. The barrel is heated by induction heating to facilitate a high and constant heat source. The porosity in the carbon profile is achieved by varying the mesh size of the carbon and binder along with changing the pitch in the screw.

### BRIEF DESCRIPTION OF THE SEVERAL VIEWS OF THE DRAWINGS

The benefits and advantages of the present invention will become more readily apparent to those of ordinary skill in the relevant art after reviewing the following detailed description and accompanying drawings, wherein:

FIG. 1 is a side view of the carbon block extruder embodying the principles of the present invention;

FIG. 2 a side view of the hopper and the chute of the carbon block extruder illustrating how the material slides into the barrel of the carbon block extruder;

FIG. 3 is a plan view of the control slide of the hopper of the carbon block extruder;

FIG. 4 illustrates the ratio of the length of the screw to the rod in the barrel of the carbon block extruder;

FIG. 5 is a side view illustrating an embodiment of a screw for more porous composite.

FIG. 6 is a side view illustrating an embodiment of a screw for less porous composite.

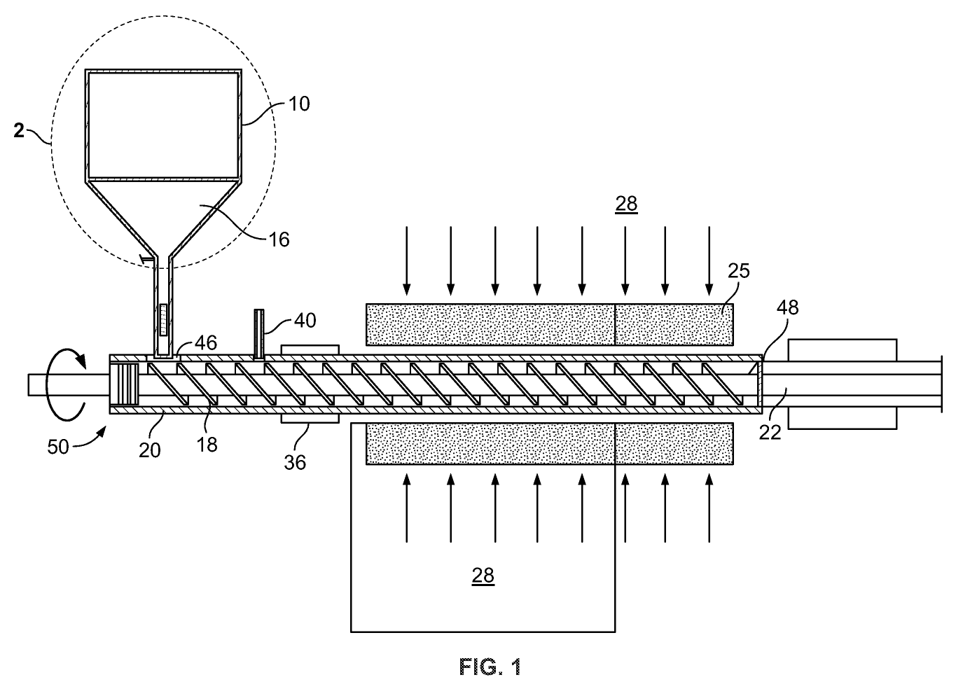

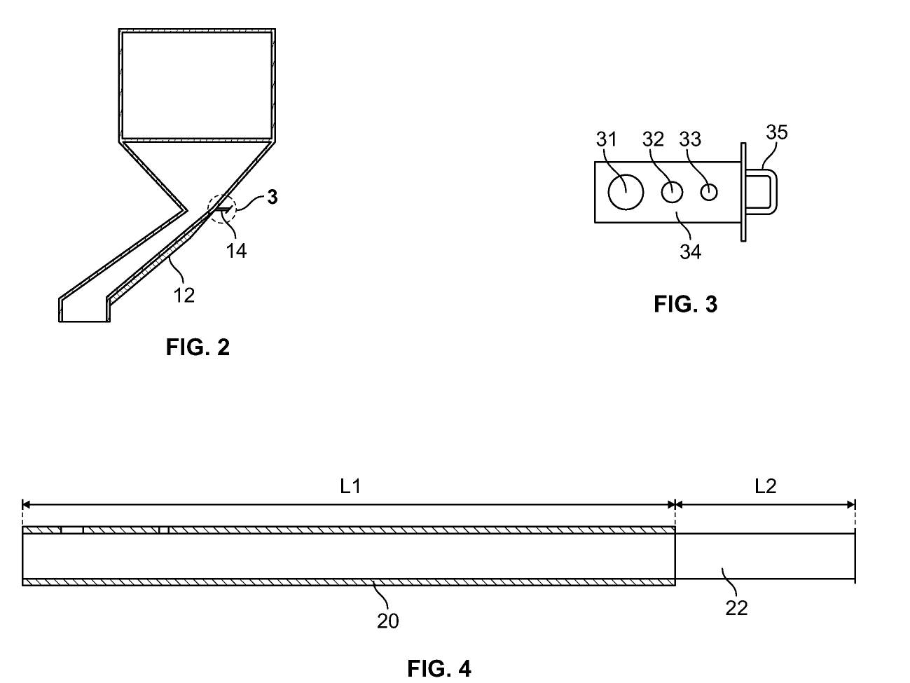

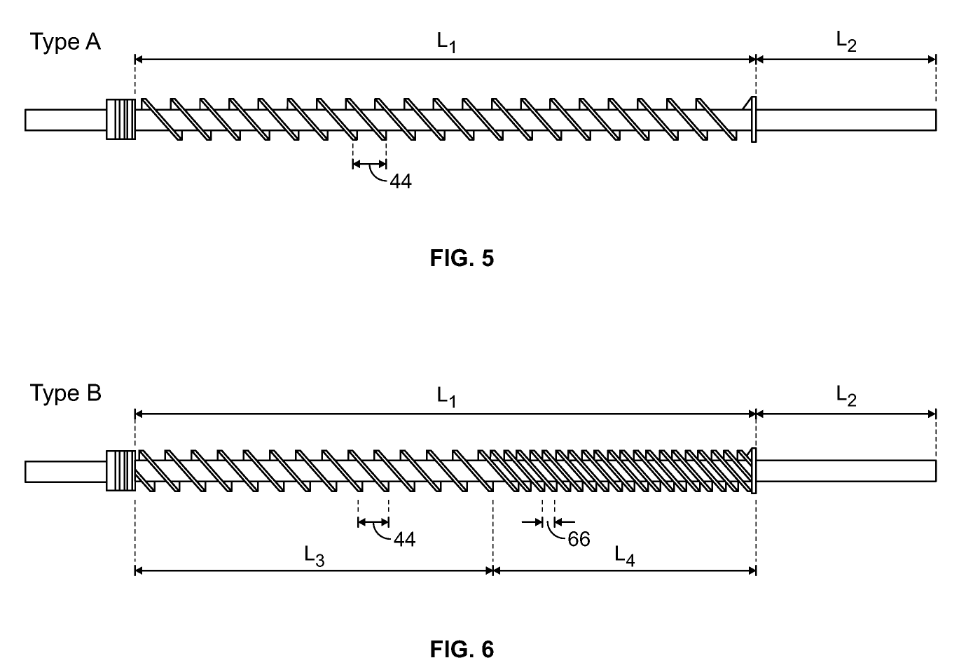

### DETAILED DESCRIPTION OF THE INVENTION

While the present invention is susceptible of embodiment in various forms, there is shown in the drawings and will hereinafter be described a presently preferred embodiment with the understanding that the present disclosure is to be considered an exemplification of the invention and is not intended to limit the invention to the specific embodiment illustrated.

It should be further understood that the title of this section of this specification, namely, “Detailed Description Of The Invention”, relates to a requirement of the United States Patent Office, and does not imply, nor should be inferred to limit the subject matter disclosed herein.

The present invention discloses a method of and apparatus for extruding consistent, uniform carbon block. In this invention, novel techniques are used to make uniform, consistent carbon blocks which overcome several issues in known carbon block extrusion.

The carbon blocks in the present invention are formed by an extrusion process in which carbon powder and a matching plasma-charged binder are mixed together. The mixture is passed from a hopper through a sieve-like platform and down a chute into an extrusion barrel. In the extrusion barrel, the mixture is propagated through the barrel using a pitched screw 18 designed for a particular carbon block porosity. While being propagated, the mixture is heated by induction heating such that the binder, and in particular a high molecular weight binder, softens and binds the carbon particles together. The mixture is propagated through the barrel and over a rod operably connected to the screw 18 to form an inner diameter of the block. The resultant hollowed, carbon tubular form is extruded from the barrel. The carbon tube is then cut to form carbon blocks.

The apparatus used to form carbon blocks includes a hopper 10, a chute 12, and a flow control slide 14. A mixture 16 is stored within the hopper 10 and flows into a barrel 20. The hopper 10 is connected to the barrel 20 by the chute 12 such that the mixture 16 of carbon powder and binder flows smoothly into the barrel 20.

The chute 12 is positioned at an angle with respect to the barrel 20. The slide 14 has holes or openings 31, 32, 33, through a panel or platform 34. In a present embodiment, the slide 14 has three openings and a handle 35, however, it is contemplated that more or less openings may be present in the slide 14.

Within the barrel 20 lies a screw 18 of length L1, having a pitch or distance 44, 66 between the threads. The barrel 20 has a gas vent 40, induction heating elements 25, and a cooling water jacket 36. Outside of and adjacent to the barrel 20 and connected to the screw 18 is a rod 22 of length L2. The present invention uses a screw 18 to feed the mixture 16 through the barrel 20.

The mixture 16 is composed of activated carbon and a polymer binder. The activated carbon is made using coconut shell, beet, wood and other cellulose materials. The polymer binders contemplated are based on low density polyethylene (LDPE), ethylene vinyl acetate (EVA), polyurethane (PU), and ultra high molecular weight polyethylene (UHMWPE).

The stream of the mixture 16 of the carbon powder and the binder into the barrel 20 from the hopper 10 is controlled two ways, using a controlled slide 14 and a chute 12. First, the amount to mixture 16 sliding out of the hopper is controlled by a slide 14 that has several apertures of varying size. The amount of opening and therefore, the amount of material released from the hopper, is controlled to match the speed of the carbon composite extruded. The flow of the carbon and binder mixture 16 is controlled by the slide 14 which controls the amount of mixture 16 that enters the barrel 20, as well as the particle size that enters the barrel.

The slide has openings 31, 32, 33 to filter undesired-sized particles of mixture 16 from entering the chute 12. If a finer particle is desired to make a less porous, tighter carbon block, then, for example opening 33 could be utilized, preventing particulate matter having diameters greater than the size of opening 33 from falling into the chute 12 and barrel 20. If larger particulate matter for the mixture 16 is desired, such as when a more porous carbon block is being made, then larger opening 31 can be used. The slide 14 is shiftable to control the size of the mesh being formed in the carbon block. In the extrusion process, the mixture 16 that is fed through the slide 14 to the barrel 20 needs to be a consistent flow to maintain uniform quality output.

Second, the flow is also controlled by using a chute 12. By not having the hopper 10 directly over the barrel 20, bridging is less likely to occur. The hopper 10 is placed such that the mixture 16 slides from the hopper 10 into the barrel 20 via a chute 12 that is at an angle relative to the barrel 20 and hopper 10. The amount of mixture 16 fed into the inlet 46 of the barrel 20 is matched to the output 48 of the extruder 50. Connecting the hopper 10 to the barrel 20 by this chute 12 minimizes the bridging of the mixture 16 in the hopper 10. In this invention the hopper is placed off-center of the barrel connected by a chute 12. The chute 12 angle is approximately 30 to 45 degrees to facilitate the sliding of the mixture 16 into the barrel.

The loose mixture 16 that has entered the barrel 20 is then processed to form a carbon block. The screw 18 is used for combining the feed of the mixture 16 mix and forming of the shape of the carbon composites. The screw 18 is modified to form the outer diameter of the carbon composite. Connected to or fashioned as an integral portion of the screw 18 is a solid rod 22 which forms the inner diameter of the carbon composite.

The mixture 16 is prevented from separating out into binder and carbon in two ways: surface charging of the binder prior to being added to the hopper and heating of the binder/carbon mixture within the barrel. First, to prevent the separation of carbon powder and binder, the binder is surface-charged so that the carbon and binder are “attached” by a weak force preventing separation. The binder is surface-modified or plasma-treated to create the surface charge prior to mixing with carbon powder.

Second, to prevent the separation of carbon powder and binder, the activated carbon and polymeric binder which form the mixture 16 are heated and the binder and the carbon begin to bond. The binder and carbon are heated until the mixture 16 reaches a temperature below the melting point of the binder where the binder begins to just soften and become “sticky”. The sintering temperature is dependent on the processing temperature of the polymeric binder used. The combination of heating and surface charging the binder prevents separation of the carbon power and binder to produce a more uniform, consistent carbon block.

In the extrusion of the carbon and binder mixture 16, the binder requires relatively little residence time in the barrel to soften so that the binder does not exceed the softening temperature and melt and flow, covering the carbon surface. For this reason, temperature control within the barrel is critical. For low softening binder materials such as LDPE, HDPE and EVA-type of material, if the temperature exceeds the softening temperature, it will begin to flow and cover the entire carbon surface making the carbon block less effective. UHMWPE is considered a more desirable binder: because of its high molecular weight, it does not flow even at relatively high temperatures, thus not covering the carbon molecules and allowing the carbon to retain much of its effective surface area for filtration.

In order to raise the temperature of the barrel high enough to soften the UHMWPE, the barrel 20 is heated by induction heating. The barrel 20 is heated by using induction heating elements or heating coils 25, induction heating shown by arrows 28, of the barrel. As the mixture 16 is propagated through the barrel, the heating source warms the mixture 16 to below the binder's melting point and the particles begin to bond, or stick, together. Because the mixture 16 is being propagated, it has little contact time with a conductive heat surface. Thus, obtaining high temperatures in the material is difficult using conductive heating sources. Either the barrel 20 would need to be longer to allow for more contact time of the mixture 16 with the conductive heating source, or the mixture 16 with high melting point binder would need to be propagated in a relatively much slower manner.

Unlike the current process of heating by conductive heater bands, inductive heating can raise the temperature of the mixture 16 faster and higher and keep the elevated temperature constant, using less energy than conductive heating. This induction heating allows for heating the barrel 20 in a few minutes and provides constant high heat, allowing softening even high molecular weight binders such as UHMWPE. Because induction heating is fast and continuous, the area of the barrel 20 being heated need not be as great as when using conductive heating for high melting point binders. The barrel 20 can remain relatively short, even when using binders with high melting points, because the time the mixture 16 has to be with the heat source does not have to be as long as in conduction heating.

Heating the barrel and maintaining a constant temperature is very important in the extrusion process. This also allows for the screw 18 to be operated at a faster rpm, enabling the mixture of carbon and binder to be heated faster at the heating zone of the barrel.

In order to contain the heat of the barrel within the heating zone, the front of the barrel is cooled by water jacket 36. The water jacket 36 placed before the heating coils 25 prevents the material/mixture 16 from heating prematurely and softening too soon, as the binder softening prematurely could result in an interruption of the flow of the feed through the chute and into the barrel 20.

The porosity of the carbon composite is controlled by the mesh size of carbon powder and binder and also by varying the screw 18 design. Carbon composites with large size pores are achieved by using carbon powder with large mesh and also using a general purpose screw 18 having a uniform pitch for the entire length of the screw 18 section. A carbon composite with smaller pores is achieved by using carbon powder of relatively finer mesh and using a screw 18 that has a relatively smaller pitcher at the near end of the screw, as shown at L4.

The porosity of the carbon block depends in part, as stated, on the mesh size of the activated carbon power and the size of the binder particles. In any given batch of carbon powder or binder, the sizes of the particles therein differ. Therefore, it is important to match mesh sizes, in other words, match carbon particle size to binder particle size, to produce consistent and uniform carbon blocks.

Table 1 shows the particle distribution of the carbon powder and a binder to make more porous carbon blocks.

TABLE 1

| CARBON PARTICLE BATCH #1 | | MATCHING BINDER BATCH #1 | |
|---|---|---|---|
| Range of Particle Size in Carbon | | Range of Particle Size in Binder | |
| batch #1: 40 to 140 mesh | | Batch #1: 80 to 180 mesh | |
| Particle Distribution by Size: | | Particle Distribution by Size: | |
| <40 mesh | 0.90% | | |
| between 40 and 50 mesh | 2.40% | | |
| between 50 and 70 mesh | 56.90% | <80 mesh | 45% |
| between 70 and 80 mesh | 18.50% | between 80 and 120 mesh | 40% |
| between 100 and 140 mesh | 6.90% | between 120 and 180 mesh | 10% |
| greater than 140 mesh | 3.90% | greater than 180 mesh | 5% |

The left hand column shows the particle mesh size for a batch of carbon powder. The right hand column shows a commonly sold commercial binder that has been sifted to show its component particle sizes. Ideally, to match the carbon and the binder, the particles would be the exact same size. However, in the present invention, the carbon on the left is matched to a binder particle size on the right, as much as is possible practically when using commercially available binder, to allow the carbon blocks to have a consistent texture and uniform porosity throughout the block. It is also contemplated that binder can be matched which is specially produced, however this is difficult and expensive. The binder used should match at least 80 percent of the carbon mesh size. For example, in the binder batch #1 shown above in Table 1, at least 85 percent of the binder particles in the batch are between 80 and 120 mesh, while over 70 percent of the carbon particles are between 50 and 80 mesh. For practical purposes, this is a carbon/binder “match” such that the entire binder batch #1 and carbon batch #1 can be mixed to form a certain porosity of block. Table 1 has the matching carbon and binder particles boxed, showing the carbon and binder mesh sizes that are used for making more porous carbon blocks.

Table 2 shows the carbon and binder mesh for making tighter carbon blocks and has the matching particles sizes boxed as well.

TABLE 2

| CARBON PARTICLE BATCH #1 | | MATCHING BINDER BATCH #1 | |
|---|---|---|---|
| Range of Particle Size in Carbon | | Range of Particle Size in Binder | |
| batch #2: 120 to 300 microns | | Batch #2: 100 to 230 microns | |
| Particle Distribution by Size: | | Particle Distribution by Size: | |
| <120 mesh | 2.00% | <100 mesh | 10% |
| between 120 and 160 mesh | 36.00% | between 100 and 130 mesh | 40% |
| between 160 and 180 mesh | 35.00% | between 130 and 160 mesh | 40% |
| between 180 and 200 mesh | 16.00% | between 160 and 230 mesh | 10% |
| greater than 200 mesh | 11.00% | | |

In TABLE 1 and TABLE 2, the term mesh refers to the number of particles per unit scale; thus, the greater the mesh, the finer the granule and the less porous the resulting combination of carbon and binder.

The activated carbon and binder can form any size mesh, but the carbon mesh used and binder used depends on the work for which the carbon block is intended. For carbon blocks that need to be more porous the carbon mesh can be between 40 and 200 mesh and, preferably, between 40 and 120. The binder used can be a polymeric mixture 16 such as LDPE, high density polyethylene (HDPE), polypropylene (PP), EVA and UHMWPE. The particle size of the binder for more porous carbon block is between about 40 and 200. For sediment and removal chlorine, odor and taste the carbon block needs to be more porous. For such blocks, the carbon powder used is between 80 and 320 mesh, and preferably between 30 and 140 mesh. Table 2 shows the carbon powder and the binder mesh size for less porous carbon blocks. The mixture of carbon powder and binder are mixed in the ratio of approximately 70 parts of carbon to 30 parts of binder, or preferably, in a ratio of approximately 80 parts of carbon to 20 parts of binder. For carbon blocks that need to be able to remove volatile organics and cysts, the carbon block should be of lesser porosity. For this, the carbon powder mesh size used is between about 80 and 320 mesh, preferably between 200 and 320 mesh.

The porosity of the carbon block is also dependent not only on the particle size used, but also on the type and style of screw 18 used. The outside diameter of the screw 18 will form the outside diameter of the carbon composite. The internal diameter of the carbon block is formed by the solid rod 22 that is attached to the end of the screw. A general purpose screw 18 having a uniform pitch for the entire length of the screw 18 section will generate a more porous carbon block. A screw 18 that has a larger pitch at the inlet, as shown in FIG. 6 at L3, and a smaller pitcher at the near end of the screw, as shown at L4, will form a less porous, or tighter, block. The screw 18 used for less porous, or tighter blocks is shown in FIG. 3. Rather than using back-pressure to compress the mixture 16, the mixture 16 is compressed in the compression zone, L4, of the screw 18 in the last 20 percent of the screw 18 having the smaller pitch 66. In a present embodiment, the pitch 66 is half the pitch size of pitch 44. The action of the screw 18 compresses the binder and carbon to give small pores in the carbon block.

When the mixture propagates through the barrel, it is important that there is a gas vent 40 to discharge the air and any gas released by the softening of the binder. The barrel is provided with a gas vent 40 which allows the gases to escape. Venting the hot gas allows for the carbon block to have a uniform texture. The barrel 20 has the section for the screw 18 and final shape forming section where there is no screw 18 but a center rod connected to the screw. The center rod forms the inner diameter (ID) of the carbon block. The outer diameter (OD) of the shape forming section forms the OD of the carbon block. In standard single screw extruders, the length to diameter ratio of the screw is 15:1. The ratio of L1 to L2 is the ratio of the screw 18 section of the barrel and final shape forming is critical. Experience has shown that L1 should be 2 to 3 times the L2 depending on the ID of the block. If L2 is too long, it creates excessively high back pressure. An L1/L2 ratio below 3 generates minimum pressure build up in the barrel and facilitates a smooth extrusion process.

In conclusion, the present method of manufacturing porous carbon blocks is an improvement over prior methods of making porous carbon blocks. The method disclosed herein is less complex than previous methods while producing a carbon block which effectively removes substances of health concern. The method decreases the separation of the carbon and binder particles in the hopper as well as the extruder, and uses no backpressure from an external source to form the carbon blocks. Finally, the present method allows for matching of carbon and binder particle sizes and forms carbon blocks of uniform density and consistency.

All patents referred to herein are incorporated by reference, whether or not specifically done so within the text of this disclosure.

In the present disclosure, the words “a” or “an” are to be taken to include both the singular and the plural. Conversely, any reference to plural items shall, where appropriate, include the singular.

From the foregoing it will be observed that numerous modifications and variations can be effectuated without departing from the true spirit and scope of the novel concepts of the present invention. It is to be understood that no limitation with respect to the specific embodiments illustrated is intended or should be inferred. The disclosure is intended to cover by the appended claims all such modifications as fall within the scope of the claims.

What is claimed is:

1. A method of extruding a porous activated carbon tubular composite comprising the steps of:
mixing an activated carbon with a polymer binder to form a loose mixture;
passing the mixture from a hopper of an extruder through a multi-apertured control slide and down an angled chute to a barrel;
propagating the mixture through the barrel using an extruder screw;
using a heating element to heat the mixture such that the loose mixture forms a tubular composite;
cooling the barrel using a water jacket;
forming an inner diameter of the tubular composite; and
extruding the resultant tubular composite.

2. The method of extruding a porous activated carbon tubular composite in accordance with claim 1, further comprising the step of:
combining the activated carbon mesh and the polymeric binder into a mixture in a ratio of at least about 90 to 10.

3. The method of extruding a porous activated carbon tubular composite in accordance with claim 1, wherein the activated carbon mesh has a size ranging from approximately 80 to 320 to about 80 to 140 and the polymeric binder has a molecular weight of about 250,000 M.W. to about 3,000,000 M.W.

4. The method of extruding a porous activated carbon tubular composite in accordance with claim 1, wherein the activated carbon mesh has a size ranging from about 200 to about 320.

5. The method of extruding a porous activated carbon tubular composite in accordance with claim 1, wherein the binder is charged prior to mixing with the carbon.

6. The method of extruding a porous activated carbon tubular composite in accordance with claim 1, wherein the binder is plasma-treated prior to mixing with the carbon.

7. The method of extruding a porous activated carbon tubular composite in accordance with claim 1, wherein the mixture passes through an aperture in the control slide prior to sliding down the chute, the aperture controlling the size and amount of mixture passing there through.

8. The method of extruding a porous activated carbon tubular composite in accordance with claim 1, wherein the angled chute is positioned at about 20 to 45 degrees relative to the barrel.

9. The method of extruding a porous activated carbon tubular composite in accordance with claim 1, wherein the hopper is positioned offset of the barrel.

10. The method of extruding a porous activated carbon tubular composite in accordance with claim 1, wherein the mixture is heated during propagation.

11. The method of extruding a porous activated carbon tubular composite in accordance with claim 10, wherein the mixture is heated in the barrel by induction heating.

12. The method of extruding a porous activated carbon tubular composite in accordance with claim 1, wherein the mixture is heated in the barrel by induction heating coils.

13. The method of extruding a porous activated carbon tubular composite in accordance with claim 1, wherein the extruder has a vent opening to remove gas from the extruder.

14. The method of extruding a porous activated carbon tubular composite in accordance with claim 1, wherein the water jacket is positioned sequentially before the heating element.

15. The method of extruding a porous activated carbon tubular composite in accordance with claim 1, wherein the extruder screw in the barrel has a uniform pitch.

16. The method of extruding a porous activated carbon tubular composite in accordance with claim 1, wherein the extruder screw has a smaller pitch at an end of the extruder screw.

17. The method of extruding a porous activated carbon tubular composite in accordance with claim 1, including an elongated shaft adjacent to the barrel wherein the shaft forms an inner diameter of the composite.

18. The method of extruding a porous activated carbon tubular composite in accordance with claim 1, wherein the tubular composite is cut to form carbon blocks.

19. A porous, activated carbon tubular composite prepared by a process comprising the steps of:
mixing an activated carbon with a similarly-sized, surface-charged polymer binder to form a loose mixture;
passing the mixture from a hopper of an extruder through a multi-apertured control slide and down an angled chute to a barrel;
propagating the mixture through the barrel using an extruder screw;
using an induction heating element to heat the mixture such that the loose mixture forms a tubular composite;
cooling the barrel using a water jacket;
forming an inner diameter of the tubular composite; and
extruding the resultant tubular composite.
